(19) United States
(12) Patent Application Publication
(10) Pub. No.: US 2014/0168963 A1
(43) Pub. Date: Jun. 19, 2014

(54) MULTI-LED LENS WITH LIGHT PATTERN OPTIMIZATION

(71) Applicant: Musco Corporation, Oskaloosa, IA (US)

(72) Inventors: Thomas A. Stone, University Park, IA (US); Myron Gordin, Oskaloosa, IA (US)

(73) Assignee: Musco Corporation, Oskaloosa, IA (US)

(21) Appl. No.: 14/093,990

(22) Filed: Dec. 2, 2013

Related U.S. Application Data
(60) Provisional application No. 61/738,827, filed on Dec. 18, 2012.

(51) Int. Cl. F21K 99/00

(52) U.S. Cl. CPC F21K 9/58
USPC 362/231

(57) ABSTRACT

An apparatus, method, and system for illumination of a target includes a lighting assembly comprising plural LED sources each having individual light output patterns of preselected color or CCT. A single shared optical component or lens, which captures and controls light output from each of the plurality of light sources; at least partially mixes the individual patterns in a composite light output distribution. Optionally a light blocking member or structure such as a deflector, baffle, or reflector can be positioned between adjacent light sources in their individual light output distribution patterns to alter their contributions to the composite light output pattern.

### CROSS REFERENCE TO RELATED APPLICATION:

This application claims priority under 35 U.S.C. §119 to provisional application Ser. No. 61/738,827 filed Dec. 18, 2012, herein incorporated by reference in its entirety.

### I. BACKGROUND OF INVENTION

It is well-known in the industry that there is a desire for different color or correlated color temperature (CCT) illumination of target areas, for various reasons. It is further well-known in the industry that different fixtures used to coordinate different color or CCT lights into one beam or target area may be difficult to aim or be otherwise hard to manipulate, which can result in undesired illumination effects. It is still further well-known in the industry that spectral distribution of various light sources influences perceived quality of light, such that mixing of different light sources having the same CCT but different spectral distribution can be advantageous.

Current LED light sources attempt to provide solutions for these problems, however providing multiple LEDs with differing color, CCT, or spectral distribution which do not use a common optic can lead to aiming problems which can result in uneven blending of light output.

Thus there is need for improvement in this technical field.

### II. SUMMARY OF INVENTION

Multiple LEDs having different colors, CCT, or spectral distribution are used with a single optic and on the same or nearly the same optic axis. These multiple LEDs may be configured to allow separate control, thereby allowing a smoothly variable color or CCT illumination to be provided without need for separate aiming. A tab, reflector or other technique can be used within the single optic to reduce the amount of area that is not illuminated evenly by the different colors, CCT, or spectral distribution.

### III. BRIEF DESCRIPTION OF THE DRAWINGS

From time-to-time in this description reference will be taken to the drawings which are identified by figure number and are summarized below.

FIG. 1A illustrates in exploded perspective a lighting module according to aspects of an exemplary embodiment of the invention.

FIG. 1B is similar to FIG. 1A with an alternative exemplary embodiment.

FIG. 1C is an enlarged isolated perspective view of the lens of FIG. 1B.

FIGS. 1D-G are isometric views of FIG. 1C.

FIGS. 2A through 2D are diagrammatic views which illustrate apparatus and methods of lighting according to aspects of the invention.

FIGS. 3A and 3B are diagrammatic views which further illustrate apparatus and methods of lighting according to aspects of the invention.

FIG. 4 is a diagrammatic view which further illustrates a lighting module according to aspects of the current invention.

### IV. DETAILED DESCRIPTION OF EXEMPLARY EMBODIMENTS

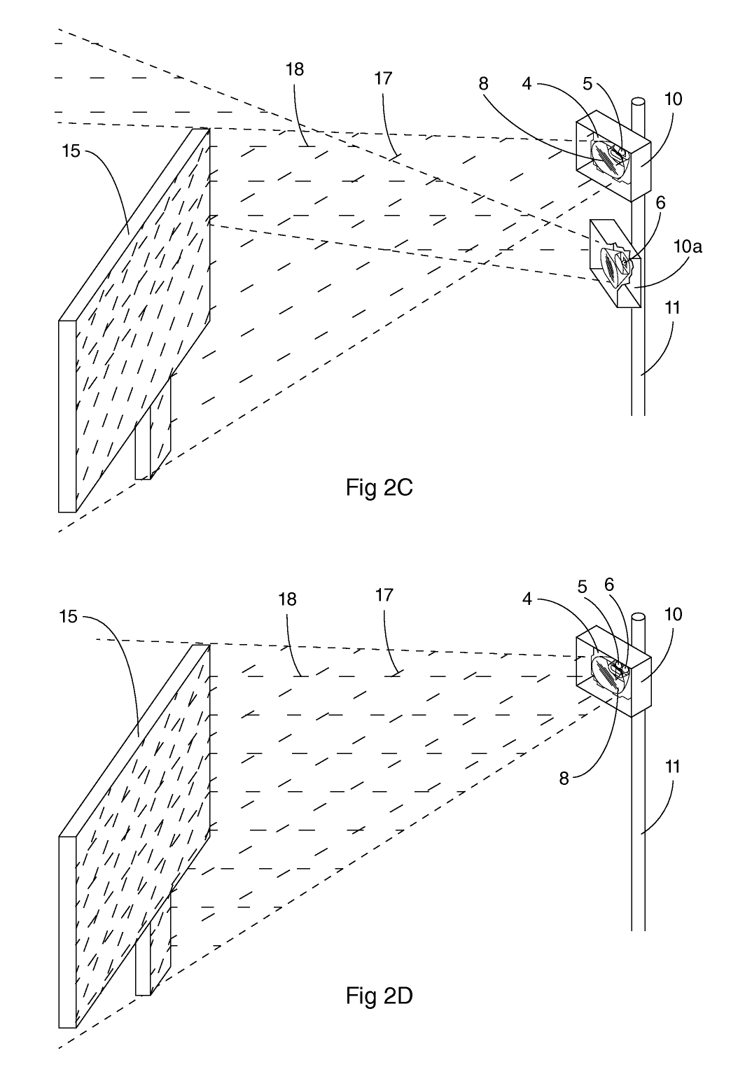

A comparison of two ways a target area may be illuminated illustrates how the concept of mixing different CCTs of lighting sources provides valuable benefits. (The process is analogous for mixing different colors or spectral distributions.) For one example, Fixture 10 of FIG. 2A illuminates object 15 using module 4 with LED 5 which has a CCT of e.g. 2400 K. (Note that the “light beam” 17 with the corresponding diagonal hatching on object 15 represents the 2400 K illumination from LED 5.) Though the object 15 is successfully illuminated, the CCT may be too low for aesthetic or other reasons. Or the CCT may be acceptable for object 15 but if a different object is substituted for which a higher CCT of illumination is desired, it is not possible to change the CCT of the illumination without physically changing the fixture or the LED within the fixture. This is not entirely satisfactory.

So in a second example, the same Fixture 10, FIG. 2B, illuminates object 15, using the same module 4 in which LED 6 which has a CCT of 5000 K has replaced LED 5. (Note that the “light beam” 18 with the corresponding horizontal hatching on object 15 represents the 5000 K illumination from LED 6.) Again, the target is successfully illuminated, but the CCT may be too high for aesthetic or other reasons, and again, if it is desired to change to a different CCT illumination, it would require physically changing the fixture or the LED(s) within the fixture. This is likewise not entirely satisfactory.

In a third example, Fixture 10, FIG. 2C, illuminates object 15, using module 4 containing LED 5 which has a CCT of 2400 K and which is projecting light beam 17. A second fixture 10a, containing LED 6 which has a CCT of 5000 K and which is projecting light beam 18 illuminates object 15. However, since LEDs 5 and 6 do not share a common optic, their aiming may not be accurate, and therefore the area on object 15 represented by diagonal hatching corresponding to light beam 17 is lit by LED 5, while the area represented by horizontal hatching corresponding to light beam 18 is lit by both LEDs 5 and 6. This results in the lower part of object 15 having a lower CCT illumination than desired, even though the intent is to blend the light of the two LEDs. A discussion of CCT can be found at Illuminating Engineering Society of North America (IESNA), and at http://www.lrc.rpi.edu/programs/nlpip/lightinganswers/lightsources/whatisCCT.asp which are incorporated by reference herein. This too is not entirely satisfactory. Thus there remains room for improvements in the art, which are provided by embodiments of the invention as envisioned.

### First Embodiment

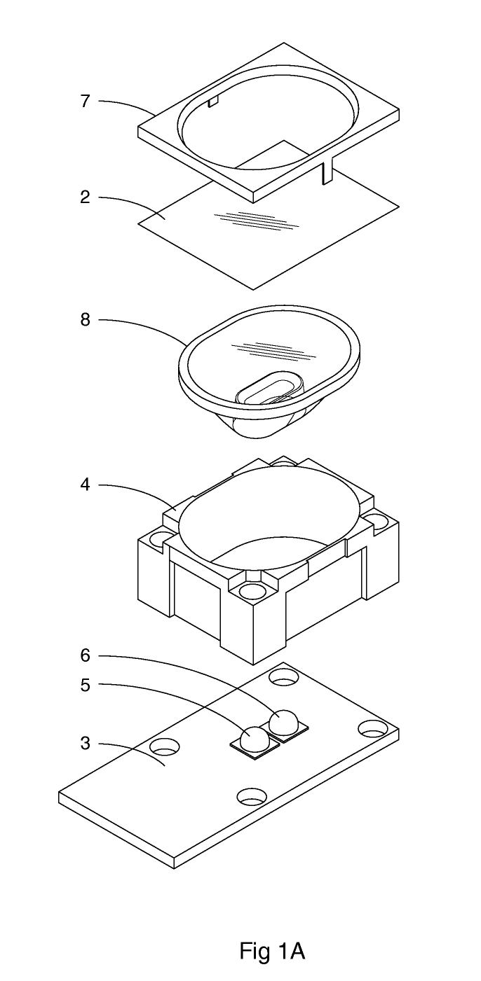

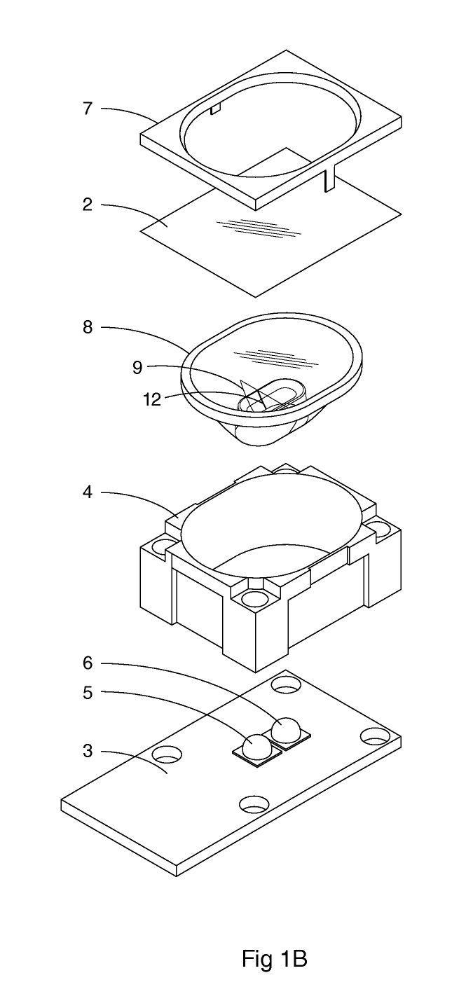

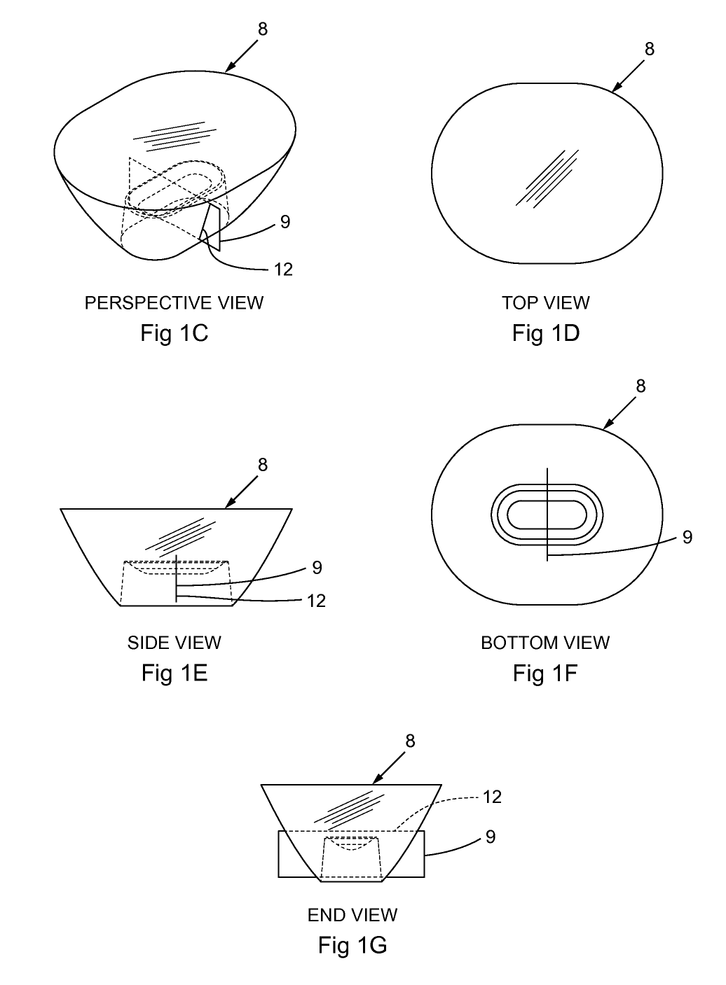

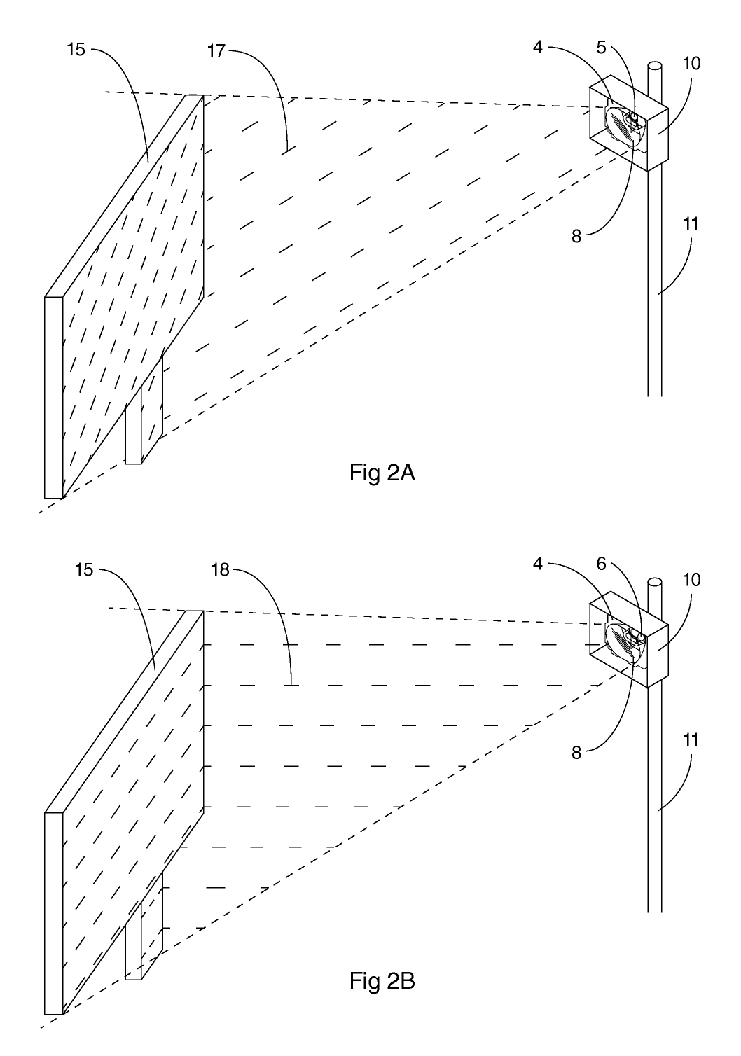

The embodiment shown in FIG. 1A, and illustrated further in FIG. 2D, is an improvement over existing art as will be seen below. Board or substrate 3 of FIG. 1A contains LEDs 5 and 6. Module housing 4 mounts over LEDs 5 and 6. Lens 8 is mounted in module housing 4 over LEDs 5 and 6. Optional diffuser sheet 2 mounts over lens 8, under retainer 7.

As can be appreciated by one skilled in the art, FIG. 1A can be assembled as follows. Module housing 4 can be attached to board 3 through the aligned 4 openings by machine screw or other attachment technique to automatically position module housing 4 relative to LEDs 5 and 6 (which would be mounted on board 3 by any of a variety of well-known methods). Module housing 4 includes a central through opening which is funnel shaped to receive lens 8 in a mating fashion. This likewise would center lens 8 relative to LEDs 5 and 6. Lens 8 could be independently attached to housing 4 by such things as interference fit, adhesive, fasteners (not shown), or other techniques. Alternatively, a retainer such as retainer 7 having an appropriately sized opening could clamp lens 8 in place to housing 4. As shown in FIG. 1A, tabs or fingers from retainer 7 could extend down to clamp retainer 7 in place on housing 4 and also clamp lens 8 into position. Note also in FIG. 1A that another optical component such as, but not limited to, the diffuser sheet 2 could be clamped in position between retainer 7 and the outlet surface of lens 8.

As can be appreciated, the combination of FIG. 1A would have a general optical axis defined by lens 8 that would extend from board 3 through the opening in housing 4, through lens 8 and diffuser 2 and through and out the opening in retainer 7. But by having plural LEDs 5 and 6, each of those sources would have its own optical axis and an output distribution pattern (which can be of a variety of distributions) relative to those LED output axes. In this embodiment, the relationship between the components is such that, when assembled, the side of lens 8 that seats into module housing 4 receives most of or all of the LED dies above the surface of board 3. In this manner, lens 8 captures and collects at that side of lens 8 essentially all of the output distribution patterns for both LEDs 5 and 6. Lens 8 would be configured, as needed or desired, to then optically produce an output distribution along the general optical axis of the assembly that would issue out of the opening in retainer 7. That output distribution could be further optically altered by component 2. In this manner, plural LED sources have individual outputs that would be collected and then issued into what will be discussed herein as a beam from the assembly relative to that assembly optical axis, even though the optical axis of each LED 5 and 6 are in different positions relative to that general assembly optical axis. One way multiple LED sources can be constructed with a single lens is set forth in commonly-owned, co-pending U.S. Patent Application Publication No. US-2013-0077304-A1, which is incorporated by reference herein in its entirety. As can be appreciated by those skilled in the art, other manners of assembling the components together, including in a more integrated fashion, are possible. The combination of FIG. 1A does, however, allow interchangeability and substitution of components as well as selection of components. This makes the combination flexible regarding results. However, as described above, reasonable preciseness of alignment of the components is substantially automatic. Also, as will be further appreciated, the combination can be scaled up or down or altered according to need or desire, including for more than two LEDs.

The embodiment found in FIG. 2D also contains fixture 10 which illuminates object 15, using module housing 4. However module housing 4 contains both LED 5 which has a CCT of 2400 K, projecting light beam 17 (represented by diagonal hatching), and LED 6 which has a CCT of 5000 K, projecting light beam 18 (represented by horizontal hatching). The LEDs share a common optic 8 and produce virtually the same projected pattern, resulting in a blended illumination that has a CCT based on the mixture of the two light sources. This is a significant improvement over previous art.

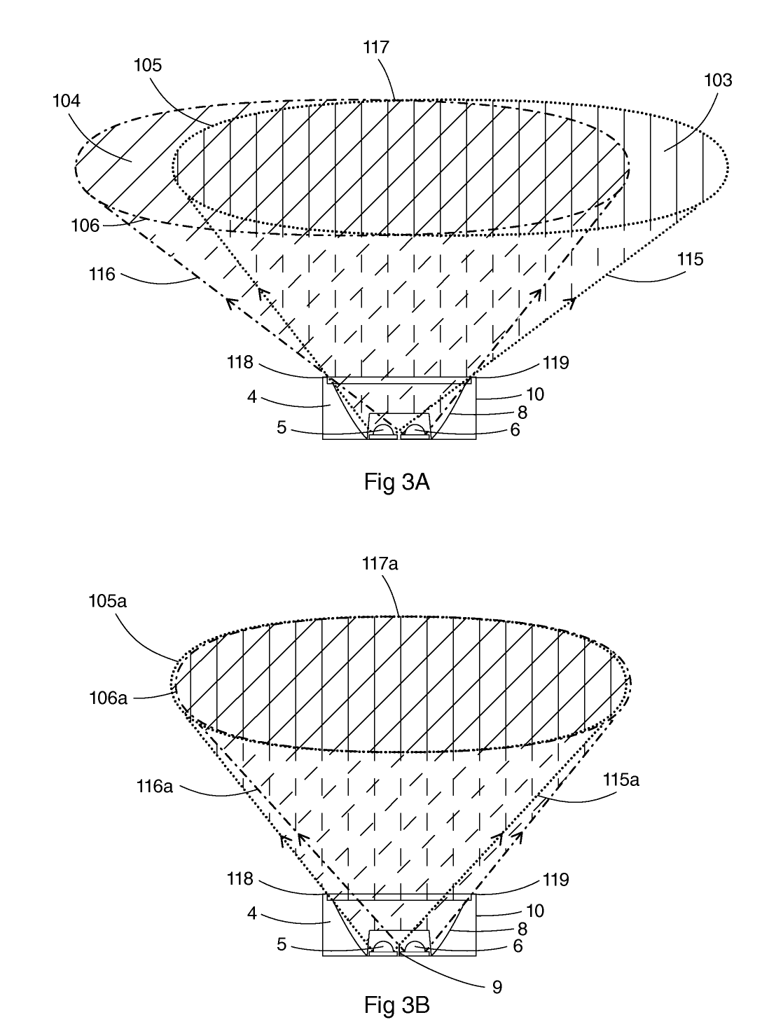

Thus the progression in lighting shown in FIGS. 2A-2D shows a better way of providing a specific color or color temperature illumination to a target by placing LEDS of differing colors or color temperatures on the same, or nearly the same optic axis. However, as can be seen in the discussion below, there is still room for further improvement at least in some situations. FIG. 3A illustrates a light module as already described and illustrated in FIG. 2D, which provides a blended light output over most of the area illuminated by fixture or module 10, but still has a discernible area in which only the output of LED 5 or LED 6, but not both LEDs, provide illumination. As can be seen by comparing FIG. 1A and FIG. 2A, orientation of the combination of FIG. 1A can be aimed as needed or desired towards a target. In many situations, the assembly of FIG. 1A will be elevated on some structure such as a pole 11 or other elevating structure (e.g., wire simple structure, bracket, etc.). The overall fixture can be mounted on that elevating structure and itself can, although is not required, have the ability to be aimed in one, two, or more axes until final positioning. As indicated in FIG. 2A, that overall output distribution from the assembly of FIG. 1A is indicated by reference numeral 17.

### Second Embodiment

The second embodiment described below, shown in FIG. 1B and further illustrated in FIG. 3B, is a significant improvement over existing art, and even can improve on the first described embodiment at least in certain circumstances. In this embodiment, board 3 of FIG. 1B contains LEDs 5 and 6. Module housing 4 mounts over LEDs 5 and 6. Lens 8 is mounted in module housing 4 over LEDs 5 and 6. Optional diffuser sheet 2 (see, e.g., FIG. 1B) mounts over lens 8, under retainer 7 (see, e.g., FIG. 1B). Light blocking member 9 is inserted in a slot 12 in lens 8, between LEDs 5 and 6. FIGS. 1C-G further illustrate views of lens 8 with member 9 mounted in slot 12. FIG. 3B illustrates an improvement which reduces to insignificant proportion the unblended illumination. As can be appreciated from FIG. 1B with further reference to FIGS. 1C-G, member 9 is essentially a structure but would end up between LEDs 5 and 6. In this embodiment, a slot would be pre-formed in lens 8 that would allow that structure 9 to be slid into place. Lens 8 with member 9 can then be seated in module housing 4 and then retainer 7 would hold everything in place in the correct orientation. Member 9 would essentially form a wall between LEDs 5 and 6 and extend a predetermined distance above the plane of board 3. The upper edge of member 9 would essentially create a visor or block to the light output distribution pattern from each LED. This will be described further below.

Another way to describe it is that member 9 would end up being positioned in a portion of the output patterns of both LEDs 5 and 6. It can be made of opaque or reflective material which would not allow any light to pass through. Alternatively, it could be made of partially light transmissive material which would let only a part of light through. Alternatively, it could be made of partially light transmissive and partially non-light transmissive or reflective materials. In any event, by being positioned in the light output distribution pattern of both LEDs, it would block or redirect a portion of the light that is incident upon it from both LEDs which would alter the light output distribution pattern, and its angle of incidence to the remainder of lens 8.

As lens 8 can be made of thermoplastic material or other materials that can be manufactured with slots, occlusions, etc., even though it is substantially a solid body, in this embodiment the slot transversely through the side of lens 8 that would receive the LEDs 5 and 6 would be designed such that the optional and interchangeable member 9 could be inserted through that slot. As indicated in FIG. 1F from a bottom view, the member 9 would essentially be a wall separating the LEDs 5 and 6. By viewing FIGS. 1C, 1E, and 1G, member 9 can extend slightly above the occlusion of cutout space to receive each LED 5 and 6. However, that height would be designed such that top edge in FIGS. 1E and 1G of member 9 would provide a cutoff for the light output distribution patterns for each LED that strike member 9.

As can be appreciated by those skilled in the art, alternatively such a member 9 could be built in or integrated into lens 8. One example would be to mold or form lens 8 out of light transmissive material but build in that member 9 in the occlusion at the LED side of the lens 8, but then coat that built in structure with opaque or reflective material. Alternative ways to create such a divider or structure with the function explained for member 9 are, of course, possible. The figures show member 9 as a wall or sheet of basically rectangular shape. It could take different forms according to need or desire. For example, its distal edge does not have to be straight. The thickness of member 9 can vary. Its body can be in different shapes. It does not have to be one piece. Member 9 could be called a baffle, surface, or other terms.

More specifically, FIGS. 3A and B illustrate generally the illumination outputs of the modules of FIGS. 1A and 1B respectively. FIG. 3A illustrates the module of FIG. 1A which does not have member 9. Optic 8 takes output from LEDs 5 and 6 and produces two output distributions that are very close but differ at their extreme ends. The target area 117 is illuminated by the blended light from LEDs 5 and 6. Note that beam 116 from LED 6 is limited by the edges 118 and 119 of optic 8. This skews the beam to the left, since LED 6 is slightly to the right of the center of the lens 8. Beam 115 from LED 5 is also limited by edges 118 and 119 of lens 8 but is skewed to the right, since LED 5 is slightly to the left of the center of the lens 8. Thus the basically elliptical cross section 106 of beam 116 illuminates the desired target area 117, but also spills over into the crescent shaped area 104. Likewise, the basically elliptical cross section 105 of beam 115 illuminates the desired target area 117, but also spills over into the crescent shaped area 103. The different hatching of the different LED light output patterns are diagrammatic to illustrate the described concepts. As can be appreciated from that hatching, in FIG. 3A the center oblong region (cross hatching at region 105) is intended to diagrammatically illustrate that only in that region would there be the desired co-mixing of output light from both LEDs. The single line hatching at oblong area 106 indicates a different, and sometimes undesired, output from that combination.

In contrast, FIG. 3B illustrates use of the module of FIG. 1B which include member 9 positioned vertically between LEDs 5 and 6. Member 9 could have various optical characteristics that could range from, for example, opaque to reflective to translucent. By appropriate coordination of optic 8, member 9, and LEDs 5 and 6, the composite pattern could be more unified than in FIG. 3A. By appropriate coordination, it is meant that the designer can, by a selection of components and/or empirical testing, decide exactly what composite output from the combination of FIG. 3D is needed or desired. For example, by comparing FIGS. 3A and 3B, the designer could balance factors as to how precise the final closeness of output cross sections 105a and 106a are. In some cases, it may be desirable to be very precise (e.g., almost identical). In others, some range of difference would be acceptable. As shown, LED output beam 116a of LED 6 still is limited by edge 119 on the right, but is limited by member 9 on the left. The result is that the light in crescent shaped area 104 of FIG. 3A is sharply reduced. Again, the comparison of FIGS. 3A and 3B shows the difference between cross sectional areas 105 and 106 versus the closeness of the same in FIG. 3B at reference numbers 105a and 106a. Likewise, the LED output beam 115a of LED 5 is still limited by edge 118 on the left, but is limited by member 9 on the right. The result is that the light in crescent shaped area 103 of FIG. 3A is also sharply reduced. The result is that target area 117a is still illuminated by the beam from LEDs 5 and 6 resulting in illumination of the desired color or CCT, but without the spill of the light from either LED 5 or 6. This means that the undesirable effects of a fringe or border of a different color or CCT from the main beam are substantially eliminated. As can be appreciated, by substantial elimination, the designer can select the preciseness of overlap of cross sections 105a and 106b. In some cases, it will be desirable to be very close or identical to the extent possible. In others there can be some variance that is acceptable.

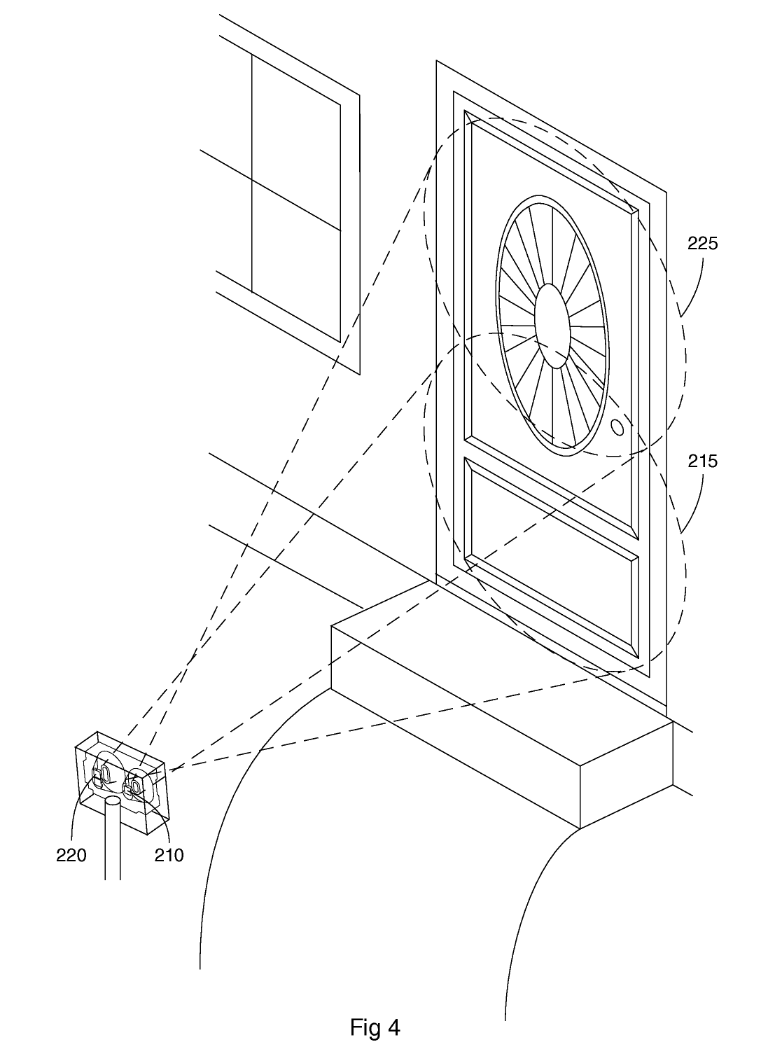

As can be appreciated, variations of the different factors and components could allow manipulation of the output characteristics from two different LEDs 5 and 6 of different color, CCT, or spectral distribution, using the same optic. As can be appreciated, the different factors and components and their variation can be selected by design, empirical testing, or techniques within the skill of those skilled in the art. Not only could that two LED combination with single optic be utilized for a specific combined output, multiples of that combination could be used in a single fixture to result in or produce any number of output effects in ways the same or analogous to those described previously herein. FIG. 4 illustrates this variation. A single fixture housing 250 could support two combinations of either FIG. 1A or FIG. 1B, or one of each, see reference numerals 210 and 220. Each could be adjusted inside that single fixture housing to produce an overall light output pattern 215 and 225, respectively aimed in whole or in part to different areas of a target area. As can be appreciated from FIG. 4, by appropriate aiming, output patterns 215 and 225 could be entirely separate. One example would be where both combinations 210 and 220 issue essentially the same output distribution characteristics (e.g., the same CCT) but they are just directed to different parts of a target area. On the other hand, different CCT characteristics can come from module 210 and 220 for different desired lighting effects. For example, beam 225 might be a different CCT because it is primarily illuminating a part of the target area where it is desirable to have a different color temperature than beam 215. This would allow the designer in a single fixture to issue different color temperature beams. Furthermore, FIG. 4 illustrates that there could be some overlap between beams 215 and 225. That gives the designer another option (the combination of those outputs) for any of a number of desirable reasons.

As can be further appreciated from FIG. 4, more than two assemblies 220 could be placed in a single fixture housing 260 on an elevating structure. They could be placed in any orientation (e.g., linearly, basset, triangular, quadrant patterns, etc. depending on the number). Still further, plural fixture housings 260 each with one or more combinations 210 or 220 could be supported on one or more elevating structures relative to a target area. The target area could be vertical, oblique, horizontal, or non-planar. As indicated in FIG. 4, it could be an architectural detail such as a residential door with stained glass in beam 225 but other parts in beam 215. The system could be scaled up or down. It could be used to eliminate a large building, billboard, wall, or structure. Alternatively, it could be used to down light to a sports field, a lawn, a parking lot, a roadway, a statue or other garden, etc. It can be applied out of one or more fixtures to both more vertical and horizontal target areas.

Options and Alternatives

The invention can take a variety of forms and embodiments. Variations obvious to those skilled in the art will be included within the invention which is defined solely by the claims. Some examples are as follows.

Aspects of the invention could be used to tune the effects of spectral distribution of individual LEDs. By “tune” it is meant that the designer can design, empirically test, or by other techniques select and then work to optimize or evolve a needed or desirable effect utilizing aspects according to the present invention. For example LEDs 5 and 6, FIG. 2D, both are rated at 3200 K but LED 5 has spectral distribution which has proportionally high blue (B) and red (R) components. Using LED 5 alone would result in vibrant lighting for blue and red objects, but poorer looking green objects. LED 6 has a proportionally higher green (G) component. Green objects will appear vibrant, but blue or red objects will not. Combining the light from G and H will not change the CRI or CCT, but will actually provide a richer array of colors.

Additionally, gross control of color, with fine control of directional placement of lighting, is possible.

Module housing 4, FIG. 2D, may be constructed to have three, four, or more LEDs (e.g., configured RGB, RGBW or RGBAW, respectively, where W=white, A=amber). Each LED uses the same optic and has virtually the same optic axis. Both color and CCT can be varied to the exact location of the combined beam; thus the object may be illuminated with fine variation (pixilation) while retaining control over each beam spot.

Multiple modules such as those described in commonly-owned, co-pending U.S. Patent Publication No. US-2013-0077304-A1, which is incorporated by reference in its entirety, could be installed in a single fixture and aimed as a group or individually.

Balancing output between individual LEDs of differing color characteristics could be done simply by running the LEDs on the same driver, which would tend to result in an approximately balanced light output from each one. This would tend to “average” the CCT of the module between the values for the individual, or for different colors or spectral distributions the resulting color or spectral distribution would be a constant, based on the specifications of the individual LEDs. However, many control schemes are possible. For example separate driver channels for the different LEDs could be provided, and balanced by adjusting one or both of the channels in the factory or at the time of installation. Another example is to provide adjustable driver channels to the LEDs which could be controlled “live” during LED operation, either manually or by control program. In this case, the operator controls the LEDs separately, which allows the CCT to be varied smoothly (e.g., from 2400 K to 5000 K) as desired. Thus the optimum or desired CCT can be selected, and if the target object or other considerations change, the CCT of the illumination may be changed as desired with only a change in control, and without physically changing any of the fixtures or LEDs.

As can be appreciated, other variations are possible. Another example of an option or alternative is that instead of lens 8 that shared optical component could be a reflector. It could be bowl-shaped, segmented, or in a variety of shapes or configurations. But it still could optionally include light blocking member 9 or other structure as described above.

What is claimed:

1. A method of providing lighting to a target area of a desired color or color temperature comprising:
a. providing one or more LED lighting modules containing two or more light sources of different colors or CCTs;
b. mixing the output of the two or more LED light sources such that the light output of a single color or CCT light source is effectively not visible on or near a target area; and
c. such that the output of the lighting module is perceived to be substantially of a single mixed color or CCT.

2. The method of claim 1 wherein the two or more light sources share a lens or reflector, the lens or reflector comprising a body extending between:
a. a first surface which is formed to substantially encapsulate light emitting portions of two or more light sources; and
b. a second surface from which light from the two or more light sources issues.

3. The method of claim 2 wherein the second surface comprises one or more of:
a. flat;
b. curved;
c. dimpled;
d. prismatic;
e. ribbed;
f. having a design of micro lens; or
g. having a void.

4. The method of claim 2 wherein the body has a generally parabolic profile.

5. The method of claim 4 where the number of LEDs is two.

6. The method of claim 5 where the light output of the two LEDs is elongated along an axis shared by the two LEDs.

7. The method of claim 6 wherein the light output at extremities of the elongated output does not contain a substantial imbalance between different colors or CCTs emitted by the two LEDs, and wherein there is not a distinguishable area within the area illuminated by the module which has a discernible difference in color or CCT from a majority of the area illuminated by the module.

8. The method of claim 7 wherein:
a. extreme ends of the lens define a cut off of light from each LED towards extreme ends of a light pattern from the module thereby tending to create an area at both extreme ends of the light pattern having a greater component of the light from the LED most distant, but wherein
b. a light blocking member between the two LEDs blocks the light pattern having a greater component of light from the LED most distant.

9. The method of claim 8 wherein power levels to the multiple LEDs are controlled separately to allow adjusting color, CCT, or spectral distribution.

10. The method of claim 9 wherein power levels may be controlled manually or by a control program while the lights are operating.

11. A luminaire comprising:
a. a housing;
b. a lighting module mounted in the housing;
c. a plurality of LED light sources in the lighting module having two or more colors or CCTs;
d. a single optical component shared by the plurality of LED light sources in the lighting module.

12. The luminaire of claim 11 wherein the optical component comprises a lens.

13. The luminaire of claim 11 wherein the optical component comprises a reflector.

14. The luminaire of claim 11 wherein a light blocking member partially blocks the output of at least one of the plurality of the LED light sources so that the light output of the luminaire is effectively a mixture without discernible separation of the two or more colors or CCTs.

15. The luminaire of claim 14 wherein the plurality of LED light sources comprises four LEDs in a two-by-two configuration.

16. The luminaire of claim 14 wherein the light blocking member is positioned within the module relative the LEDs by a slot across the portion of the optical component nearest the LED light sources.

17. The fixture of claim 11 comprising a plurality of said lighting modules in the fixture.

18. The fixture of claim 17 wherein the lighting module are adjustable relative to the fixture.

19. A light fixture comprising:
a. plural LED sources of differing output color or CCT; and
b. a shared lens for the plural LED sources.

20. The fixture of claim 19 wherein the lens has a perimeter and an optical axis, the plural light sources are in different positions relative the optical axis and produce individual light source output patterns; and a structure is positioned between at least two of the LED sources to alter a portion of the individual output pattern of both light sources.

21. The fixture of claim 20 wherein the structure comprises a light blocking member extending into the individual output patterns and blocking or redirecting at least a portion of each individual output pattern to a distal edge.

22. The fixture of claim 21 wherein the light blocking member in whole or in part comprises an opaque, partially light transmissive, or reflective portion.
